(19) United States
(12) Patent Application Publication
(10) Pub. No.: US 2026/0339417 A1
(43) Pub. Date: Oct. 29, 2026

(54) COMMANDED AND OPPORTUNISTIC SLEEP MODES IN A SYSTEM-ON-CHIP

(71) Applicant: QUALCOMM INCORPORATED, San Diego, CA (US)

(72) Inventors: Shriharsha CHEBBI, Hyderabad (IN); Lakshmi Narayana PANUKU, Hyderabad (IN); Nirav Narendra DESAI, Hyderabad (IN); Joshua STUBBS, Longmont, CO (US); Sai Santhosh VAGINEPALLI, Khammam (IN); Venkatesh RAVIPATI, Guntur (IN); Prasad Rao KOLETI, Hyderabad (IN)

(21) Appl. No.: 19/193,444

(22) Filed: Apr. 29, 2025

(51) Int. Cl. G06F 1/3228

(52) U.S. Cl. CPC G06F 1/3228

(57) ABSTRACT

A system-on-chip (SoC) may enter a sleep state in both commanded and opportunistic modes. Power votes may be received from SoC subsystems in a main power domain when the subsystems are entering a low-power mode. A winning vote may be determined based on the received power votes. An indication that the subsystems are entering the low-power mode in the commanded mode or opportunistic mode may be provided to an electrically independent island (EII) power domain based on the winning vote. The EII may then enter a low-power mode, resulting in the SoC as a whole being in a low-power or sleep state.

### DESCRIPTION OF THE RELATED ART

A computing device may include components or subsystems such as processors, memory, input and output components, etc. Processor subsystems may include, for example, central processing units (CPUs), graphics processing units (GPUs), digital signal processors (DSPs), neural processing units (NPUs), etc. Wireless computing devices may also include radio transceiver subsystems, also referred to as modems. The multiple subsystems and other components may be integrated in a “system-on-chip” or “SoC.” Mobile computing devices, such as cellular handsets, automotive computing devices, so-called Internet-of-Things (IOT) devices, wearable devices, etc., are examples of computing devices that may include SoCs. As mobile computing devices may be battery powered, they may incorporate power-saving techniques. A common power-saving technique involves placing the SoC into a low-power mode or sleep state during a period of processing inactivity or idleness.

When a subsystem determines it no longer has a processing load (e.g., the subsystem has been idle for more than a threshold amount of time), it may enter the low-power mode. This manner of a subsystem entering into a low-power mode may be referred to as “opportunistic.” Another way a subsystem may enter a low-power mode, which may be referred to as “commanded,” is in response to an external trigger event. In commanded entry, a triggering subsystem, such as a CPU or an application processing subsystem (APSS) may detect the trigger event and, in response, command individual subsystems to enter the low-power mode. If all subsystems have entered the low-power mode, the SoC's power control circuitry may power off or “collapse” one or more power supply rails to the inactive subsystems.

Some SoCs may include a power “island” that is separate or isolated in some respects from the one or more main power domains in which most subsystems operate. Such a separate power domain may be referred to as an electrically independent island (EII), a power island, a voltage island, etc. In some examples, an EII may be used to support operation in a safety-related application, such as, for example, an automotive computing system that assists with driving the vehicle. The EII may remain powered for at least some portion of the time during which the power supply rails to inactive subsystems in the main power domain are powered off. For reasons that may include constraints on communication paths among the relevant SoC components, some SoCs that include an EII may support only commanded entry and not support opportunistic entry, while other SoCs that include an EII may support only opportunistic entry and not support commanded entry. It would be desirable for a SoC having an EII to support both commanded entry and opportunistic entry into a low-power mode.

### SUMMARY OF THE DISCLOSURE

Systems, methods, and other examples of entering a low-power mode in a system-on-chip (SoC) are disclosed.

An exemplary method for entering a low-power mode in a SoC may include receiving a power vote from each of a plurality of subsystems in a first power domain when each of the plurality of subsystems is entering the low-power mode. The method may also include determining a winning vote based on power votes received from the plurality of subsystems. The method may further include providing an indication of entry of the plurality of subsystems into the low-power mode to a second power domain based on the winning vote.

An exemplary system for entering a low-power mode in a SoC may include aggregated resource control circuitry and low-power mode resource circuitry. The aggregated resource control circuitry may be configured to receive a power vote from each of a plurality of subsystems in a first power domain when each of the plurality of subsystems is entering the low-power mode. The low-power mode resource circuitry may be configured to receive power votes from the aggregated resource control circuitry and to determine a winning vote based on the power votes. The low-power mode resource circuitry may further be configured to provide an indication of entry of the plurality of subsystems into the low-power mode to a second power domain based on the winning vote.

An exemplary SoC may include a plurality of subsystems in a first power domain and a low-power mode resource controller. The low-power mode resource controller may be configured to receive a power vote from each of the plurality of subsystems when each of the plurality of subsystems is entering the low-power mode. The low-power mode resource controller may also be configured to determine a winning vote based on power votes received from the plurality of subsystems. The low-power mode resource controller may further be configured to provide an indication of entry of the plurality of subsystems into the low-power mode to a second power domain based on the winning vote.

### BRIEF DESCRIPTION OF THE DRAWINGS

In the Figures, like reference numerals refer to like parts throughout the various views unless otherwise indicated. For reference numerals with letter character designations such as “101A” or “101B”, the letter character designations may differentiate two like parts or elements present in the same Figure. Letter character designations for reference numerals may be omitted when it is intended that a reference numeral encompass all parts having the same reference numeral in all Figures.

FIG. 1 is a block diagram of portions of a system-on-chip (SoC) and related components in a computing device, in accordance with exemplary embodiments.

FIG. 2 is a functional block diagram of a system for entering a low-power mode in an SoC, in accordance with exemplary embodiments.

FIG. 3 is an operation sequence diagram illustrating a commanded-entry method for entering a low-power mode, in accordance with exemplary embodiments.

FIG. 4 is an operation sequence diagram illustrating an opportunistic-entry method for entering a low-power mode, in accordance with exemplary embodiments.

FIG. 5 is a flow diagram illustrating a method for entering a low-power mode in a SoC, in accordance with exemplary embodiments.

FIG. 6 is a block diagram of an aggregated resource controller, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

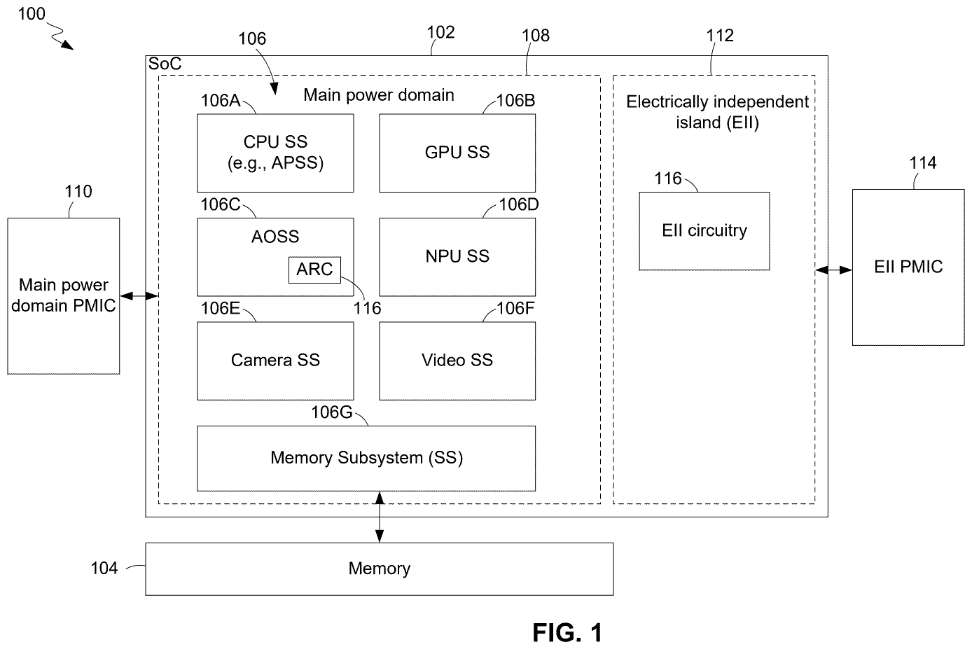

As shown in FIG. 1, in an illustrative or exemplary embodiment a system 100 may include a system-on-chip (SoC) 102. The system 100 may also include a memory 104 with which the SoC 102 may conduct memory transactions. The SoC 102 may include any number of subsystems (SS) 106, such as, for example: a central processing unit or application processing subsystem (APSS) 106A, a graphics processing unit (GPU) subsystem 106B, an “always-on” subsystem (AOSS) 106C, a neural processing unit (NPU) subsystem 106D, a camera subsystem 106E, a video subsystem 106F, a memory subsystem 106G, etc. The subsystems 106 may operate in a main power domain 108 and may communicate with one another and with components external to the main power domain 108 via one or more buses or data communication interconnects (not shown). The system 100 may be included in any type of computing device, such as, for example, a cellular telephone or smartphone, a desktop, laptop, palmtop or tablet computer, a so-called Internet-of-Things (IOT) device, a wearable device, an automotive computing device, etc.

The system 100 may further include a power management integrated circuit (PMIC) 110 that provides power to the main power domain 108. That is, the PMIC 110 may power one or more voltage rails (not separately shown) supplying power to the subsystems 106. The PMIC 110 may be configurable to supply power to selected ones of the subsystems 106 so that, for example, one or more subsystems 106 may be powered on (i.e., their voltage rails are turned on or actively supplying power) while one or more others of the subsystems 106 may be powered off (i.e., their voltage rails are turned off or “collapsed.”) The PMIC 110 may be controlled by power control circuitry that may be included in, or have portions distributed among, one or more of the subsystems 106, such as APSS 106A, the AOSS 106C, etc. Through such power control circuitry, subsystems 106 may request voltage levels or power/performance states for their supply voltage rails. For example, when a subsystem 106 determines it no longer has a processing load (e.g., the subsystem 106 has been idle for more than a threshold amount of time), it may request a low-power mode.

Subsystems 106 may submit the aforementioned requests in the form of voltage votes, and the voltage to which the power control circuitry may (via the PMIC 110) set the various supply voltage rails may be based on the voltage votes. Although not directly related to the solutions described herein, general power control techniques may also include adjusting clock frequencies, and power control circuitry (not shown) may control clock frequencies based on frequency votes or based on a generalized “performance state” vote that relates to both voltage and frequency. To control power in this manner, the power control circuitry may include dynamic clock and voltage scaling (DCVS) (also known as dynamic frequency and voltage scaling (DFVS)) circuitry (not shown). Voltage rails, bandwidth, etc., may be referred to generally as “resources.” Resources shared among multiple subsystems 106 or other components and may be referred to as shared resources. The power control circuitry may determine and set the values of shared resources based on voting. An additional voting feature described below, which may be referred to as low-power mode voting or sleep state voting, may be provided in the SoC 102 in accordance with the solutions described herein.

Receiving subsystem votes for shared resources and basing the determinations of values for the shared resources on the received votes may be referred to as “aggregation.” In the example illustrated in FIG. 1, aggregation circuitry or aggregated resource control (ARC) circuitry 116 may be included in the AOSS 106C. Generally, the AOSS 106C may include various circuitry that remains powered on even when most other subsystems 106 are powered off. Nevertheless, in other examples (not shown) such aggregation or voting circuitry may be included in any other subsystem or other SoC portion.

The SoC 102 may also include a power island or electrically independent island (EII) 112. Although the EII 112 may be a type of power domain, it may be distinguished from the above-described main power domain 108 in that the EII 112 may be powered by an EII PMIC 114 that is separate from the above-described PMIC 110. The EII PMIC 114 may power one or more voltage supply rails (not separately shown) supplying power to various EII circuitry 116 in the EII 112. In some examples of the system 100, the EII 112 may provide functions that relate to safe operation of the subsystems 106. For example, in an automotive computing system the EII 112 may monitor for conditions in the subsystems 106 that could conceivably impair safe operation of the vehicle.

A “commanded” mode of placing the SoC 102 into a low-power mode or sleep state may be provided. That is, a triggering subsystem, such as, the APSS 106A, may be configured to detect a triggering event. For example, in an automotive computing system turning the vehicle (ignition) off may be such an event. In response to detecting the event, the APSS 106A may command individual subsystems 106 to enter a low-power mode, i.e., may initiate transitioning the subsystems 106 from an active mode to a low-power mode. In other words, in the commanded mode, the subsystems 106 enter the low-power mode in response to a command to enter the low-power mode. An “opportunistic” mode of placing the SoC 102 into the low-power mode or sleep state may also be provided. That is, when a subsystem 106 determines it no longer has a processing load (e.g., the subsystem 106 has been idle for more than a threshold amount of time), it may enter the low-power mode (i.e., on its own initiative). When all subsystems 106 and the EII 112 have entered a low-power mode, the entire SoC 102 may be referred to as having entered a low-power mode or sleep state. Such a sleep state, in which nearly all of the circuitry of the SoC 102 is powered off, may be referred to as rock-bottom sleep (RBS). The RBS state thus may be entered through either commanded or opportunistic modes.

As the EII 112 may serve a safety-related monitoring function, it may need to remain vigilant during transitioning of the subsystems 106 to low-power modes. For example, when the subsystems 106 may be entering a low-power mode, the EII 112 may refrain from entering such a low-power mode (even if the EII 112 is otherwise idle) until all of the subsystems 106 have entered the low-power mode. The solutions described herein may address challenges in providing communications among the triggering subsystem (e.g., APSS 106A), other subsystems 106, the EII 112, etc., to support such operation of the EII 112 and to support both commanded and opportunistic modes of entering a low-power mode.

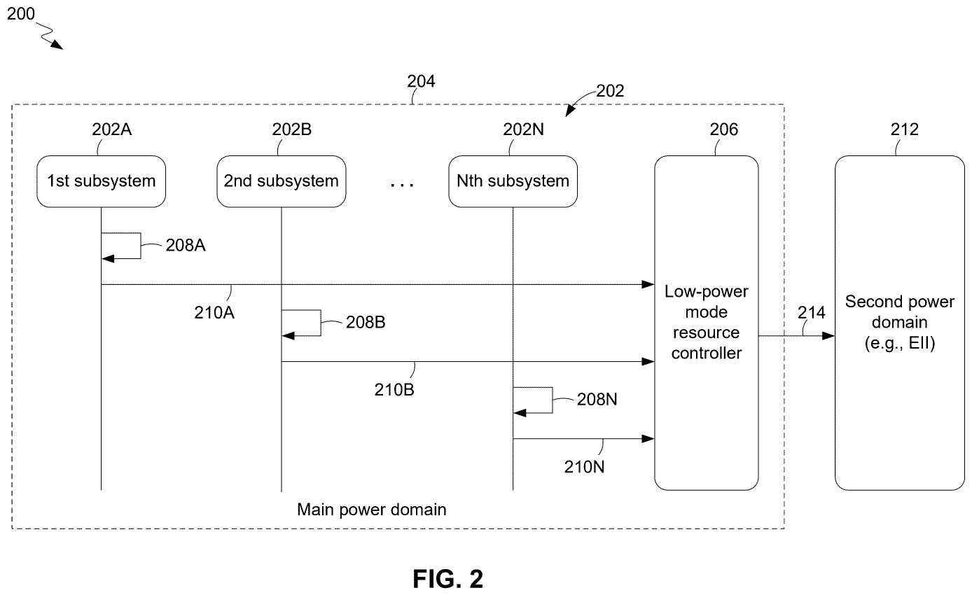

As shown in FIG. 2, a system 200 may include features for entering a low-power mode. The system 200, shown in functional block diagram form, may illustrate an example of operation of the above-described system 100 (FIG. 1). Accordingly, the system 200 may include any number of subsystems 202, such as a first subsystem 202A, a second subsystem 202B, etc., through an Nth subsystem 202N. That is, the subsystems 202 may be examples of the above-described subsystems 106 (FIG. 1). The subsystems 202 may operate in a main power domain 204.

The system 200 may also include a low-power mode resource controller 206. In the examples described herein, the low-power mode resource controller 206 may be a feature included in the above-described ARC 116 (FIG. 1). Nevertheless, in other examples the low-power mode resource controller 206 may be provided in any other SoC subsystem or circuitry. The subsystems 202A, 202B, etc., through 202N may enter low-power modes, either opportunistically or as commanded, as indicated by the operations 208A, 2028B, etc., through 208N, respectively. When the subsystems 202A, 202B, etc., through 202N enter their low-power modes, the subsystems 202A, 202B, etc., through 202N may provide power votes 210A, 210B, etc., through 210N, respectively, to the low-power mode resource controller 206.

Each power vote 210A-210N may be of one of three types: an opportunistic entry vote, a commanded entry vote, or a remain active vote. A subsystem 202 may submit a remain active vote when the subsystem 202 determines that it will continue to have a processing load and thus should not enter a low-power mode. The low-power mode resource controller 206 may receive the power votes 210A-210N and determine a winning vote. Each type of power vote may have a different value: the opportunistic vote may have a first value; the commanded entry vote may have a second value greater than the first value; and the remain active vote may have a third value greater than the second value. The low-power mode resource controller 206 may determine the winning vote by determining a maximum value among the power votes received from the subsystems 202. For example, an opportunistic vote may have a value of one, a commanded entry vote may have a value of two, and a remain active vote may have a value of three. When at least one of the power votes 210A-210N is a remain active vote (having a value of three), then the winning vote is remain active because three is the maximum value of all the received power votes 210A-210N. When none of the power votes 210A-210N is a remain active vote (having a value of three) but at least one of the power votes 210A-210N is a commanded entry vote (having a value of two), then the winning vote is commanded entry because two is the maximum value of all the received power votes 210A-210N. When none of the power votes 210A-210N is a remain active vote (having a value of three) or a commanded entry vote (having a value of two) but at least one of the power votes 210A-210N is an opportunistic entry vote (having a value of one), then the winning vote is opportunistic entry because one is the maximum value of all the received power votes 210A-210N.

The system 200 may further include a second power domain 212. The second power domain 212 may be an example of the above-described EII 112 (FIG. 1). The low-power mode resource controller 206 may provide to the second power domain 212 an indication 214 that the subsystems 202 are entering into the low-power mode. The indication 214 may be based on the winning vote. The indication 214 may include information indicating the type of entry: commanded or opportunistic.

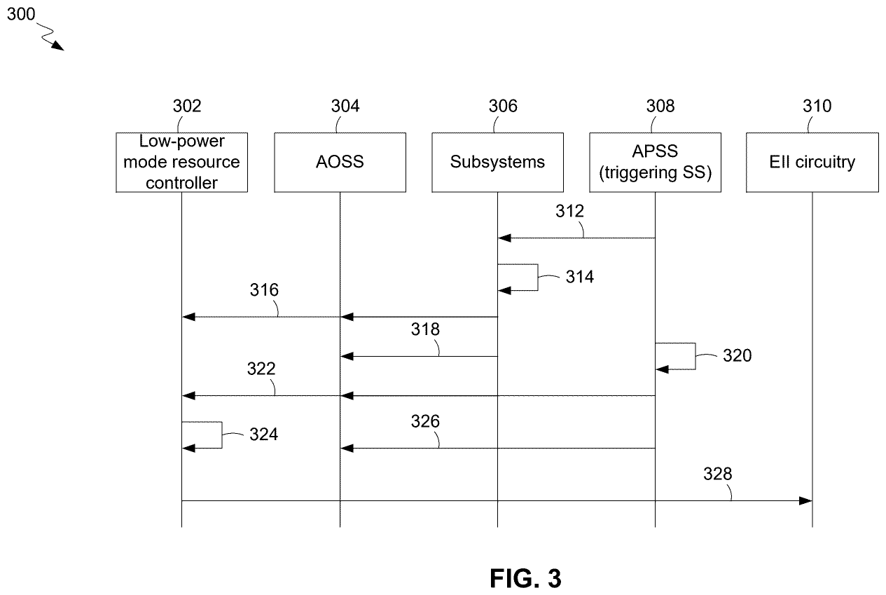

As shown in FIG. 3, an operational sequence diagram 300 illustrates an example of commanded entry into low-power mode. The sequence diagram 300 may illustrate an example of operation of the above-described system 100 (FIG. 1) or 200 (FIG. 2). Shown in FIG. 3 are: a low-power mode resource controller 302, an AOSS 304, subsystems 306, an APSS 308, and EII circuitry 310. The low-power mode resource controller 302 may be an example of the above-described low-power mode resource controller 206 (FIG. 2). The AOSS 304 may be an example of the above-described AOSS 106C (FIG. 1). Although as noted above with regard to FIG. 2 the low-power mode resource controller 206 may be an ARC feature or otherwise associated with one of the subsystems, and although as shown in FIG. 1 an AOSS and APSS may be grouped generally among the various subsystems 106, for purposes of clarity in FIG. 3 the low-power mode resource controller 302, the AOSS 304, the subsystems 306, and the APSS 308 are shown separately from each other. Note that the low-power mode resource controller 302, the AOSS 304, the subsystems 306, and the APSS 308 are all in a main power domain (not shown in FIG. 3), while the EII circuitry 310 is in an EII (not shown in FIG. 3).

In operation, the APSS 308, acting as a triggering subsystem, may respond to a triggering event (not shown) by providing a sleep entry command 312 to each of the subsystems 306. In response to the sleep entry command 312, each of the subsystems 306 enters the low-power mode, as indicated by the operations 314. Although not shown in FIG. 3, power supply voltage rails to the subsystems 306 may then be powered down. Also when the subsystems 306 are entering the low-power mode, the subsystems 306 may provide power votes 316 to the low-power mode resource controller 302. In the example illustrated in FIG. 3, the power vote that the low-power mode resource controller 302 receives from each of the subsystems 306 is a commanded entry vote, based on the sleep entry command 312. The subsystems 306 may remove their power votes after they have been received, as indicated by the operations 318. Note that the AOSS 304 may participate in the vote messaging, and the operations 318 relating to removing power votes may be directed to the AOSS 304. Nevertheless, in other examples the power votes may be provided and, in some examples, removed, in any other manner.

In the example illustrated in FIG. 3, the APSS 308 (i.e., the triggering subsystem) similarly may enter the low-power mode, as indicated by the operations 320, and may provide a commanded entry vote 322 to the low-power mode resource controller 302. The low-power mode resource controller 302 may determine a winning vote based on the power votes it received, as indicated by the operations 324. The APSS 308 may remove its power vote after it has been received, as indicated by the operation 326. In this example, the power votes received from the subsystems 306 and from the APSS 308 are all commanded entry votes. Accordingly, the winning vote is commanded entry. The low-power mode resource controller 302 may then provide to the EII circuitry 310 an indication 328 that the subsystems 306 (and APSS 308, which is also a subsystem in this context) are entering into the low-power mode based on a commanded entry mode. In a commanded entry, the EII circuitry 310 enters the low-power mode similarly to the subsystems 306 and APSS 308. The indication 328 is, in effect, a command to the EII circuitry 310 to enter the low-power mode. The indication 328 may be implemented in any manner, such as, for example, an interrupt. Accordingly, in response to the indication 328 the EII circuitry 310 enters the low-power mode. Although not shown in FIG. 3, power supply voltage rails to the EII may be powered down. Note that in an example in which the EII circuitry 310 is safety-related, commanding the EII circuitry 310 to enter the low-power mode only after the subsystems 306 and APSS 308 have entered the low-power mode may ensure that the EII circuitry 310 no longer needs to monitor the subsystems 306 and APSS 308 when the EII circuitry 310 enters the low-power mode. When both the main power domain and the EII are in the low-power mode, the power mode or state of the SoC as a whole may be referred to as rock-bottom sleep (RBS).

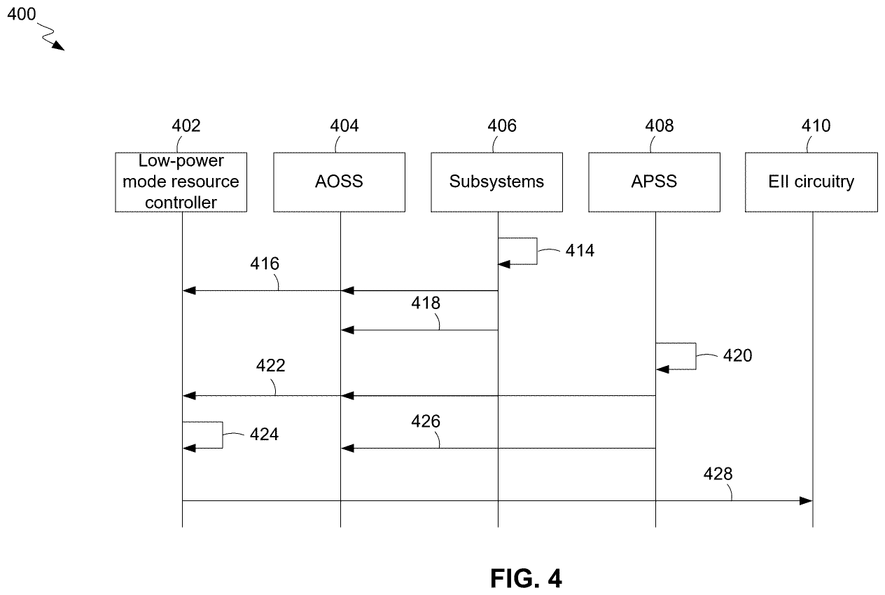

As shown in FIG. 4, an operational sequence diagram 400 illustrates an example of opportunistic entry into low-power mode. The sequence diagram 400 may illustrate an example of operation of the above-described system 100 (FIG. 1) or 200 (FIG. 2). Shown in FIG. 4 are: a low-power mode resource controller 402, an AOSS 404, subsystems 406, an APSS 408, and EII circuitry 410. The low-power mode resource controller 402 may be an example of the above-described low-power mode resource controller 206 (FIG. 2). The AOSS 404 may be an example of the above-described AOSS 106C (FIG. 1). Although as noted above with regard to FIG. 2 the low-power mode resource controller 206 may be an ARC feature or otherwise associated with one of the subsystems, and although as shown in FIG. 1 an AOSS and APSS may be grouped generally among the subsystems 106, for purposes of clarity in FIG. 4 the low-power mode resource controller 402, the AOSS 404, the subsystems 406, and the APSS 408 are shown separately from each other. Note that the low-power mode resource controller 402, the AOSS 404, the subsystems 406, and the APSS 408 are all in a main power domain (not shown in FIG. 4), while the EII circuitry 410 is in an EII (not shown in FIG. 4).

In operation, when each of the subsystems 406 determines it no longer has a processing load (e.g., it has been idle for more than a threshold amount of time), it may enter the low-power mode, as indicated by the operations 414. Although not shown in FIG. 4, power supply voltage rails to the subsystems 406 may then be powered down. Also when the subsystems 406 are entering the low-power mode, the subsystems 406 may provide power votes 416 to the low-power mode resource controller 402. In the example illustrated in FIG. 4, the power vote that the low-power mode resource controller 402 receives from each of the of subsystems 406 is an opportunistic entry vote. The subsystems 406 may remove their power votes after they have been received, as indicated by the operations 418. Note that the AOSS 404 may participate in the vote messaging, and the operations 418 relating to removing power votes may be directed to the AOSS 304. Nevertheless, in other examples the power votes may be provided and, in some examples, removed, in any other manner.

In the example illustrated in FIG. 4, the APSS 408 may, like the other subsystems 406, determine it no longer has a processing load (e.g., it has been idle for more than a threshold amount of time), and may therefore enter the low-power mode, as indicated by the operation 420. Like the other subsystems 406 in this example, when entering the low-power mode the APSS 408 may provide an opportunistic entry vote 422 to the low-power mode resource controller 402. The low-power mode resource controller 402 may determine a winning vote based on the power votes it received, as indicated by the operations 424. The APSS 408 may remove its power vote after it has been received, as indicated by the operation 426. In this example, the power votes received from the subsystems 406 and from the APSS 408 are all opportunistic entry votes. Accordingly, the winning vote is opportunistic entry. The low-power mode resource controller 402 may then provide to the EII circuitry 410 an indication 428 that the subsystems 306 (and APSS 308, which is also a subsystem in this context) are entering into the low-power mode based on an opportunistic entry mode. In an opportunistic entry, the EII circuitry 410 may determine whether it, too, enters the low-power mode. For example, the EII circuitry 410 may determine whether it is idle. The EII circuitry 410 may not be idle if, for example, it is waiting for communications with an external (to the EII) component to be completed. The indication 428 is, in effect, an indication that the EII circuitry 410 has the opportunity to enter the low-power mode. If the EII circuitry 410 decides to enter the low-power mode, power supply voltage rails (not shown) powering the EII may be powered down. When both the main power domain and the EII are in the low-power mode, the SoC may be in a RBS state.

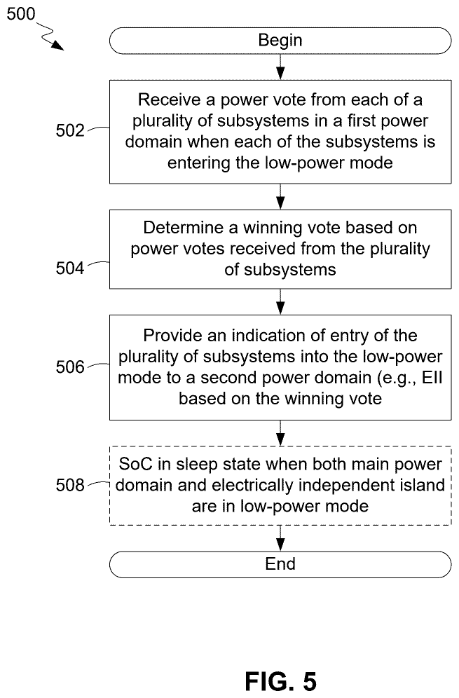

In FIG. 5, a method 500 for entry into a low-power mode in a SoC is shown in flow diagram form. As indicated by block 502, the method 500 may include receiving a power vote from each of a plurality of subsystems in a first power domain when each of the plurality of subsystems is entering the low-power mode. Receiving the power votes may be performed or controlled by, for example, a low-power mode resource controller. The subsystems may enter the low-power mode opportunistically or in a commanded manner. As indicated by block 504, the method 500 may also include determining a winning vote based on power votes received from the plurality of subsystems. Determining a winning vote may be performed or controlled by, for example, the low-power mode resource controller. As indicated by block 506, the method 500 may further include providing an indication of entry of the plurality of subsystems into the low-power mode to a second power domain based on the winning vote. Providing the indication may be performed or controlled by, for example, the low-power mode resource controller. As indicated by block 508, in some examples of the method 500, the SoC as a whole may be in a low-power mode or sleep state when both the first (e.g., main) power domain and second (e.g., EII) power domain are in a low-power mode. When the mode of entry into the low-power sleep state is commanded, the second power domain is commanded to enter the low-power domain, while when the mode of entry into the low-power sleep state is opportunistic, the second power domain may enter the low-power domain (i.e., opportunistically).

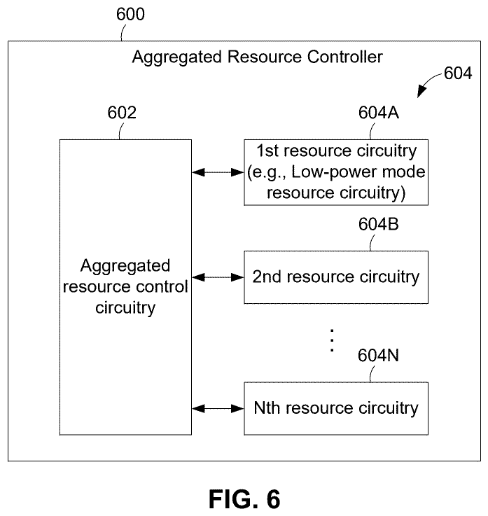

In FIG. 6, an aggregated resource controller 600 or ARC is shown as including aggregated resource control circuitry 602 and any number of associated resources 604 or ARC resources. The aggregated resource control circuitry 602 may be configured to receive shared resource votes, including power votes, from SoC subsystems as described above. The different resources 604 may be associated with different types of aggregation. For example, the resources 604 may include first resource circuitry 604A configured to receive power votes via operation of the aggregated resource control circuitry 602, to determine a winning vote based on the power votes, to provide an indication of entry of voting subsystems into low-power mode, and to otherwise operate in accordance with the methods described herein. In some examples, the above-described low-power mode resource controllers 206 (FIGS. 2), 302 (FIGS. 3), 402 (FIG. 4), etc., may comprise the aggregated resource control circuitry 602 and the first resource circuitry 604A. The resources 604 may further include second resource circuitry 604B, etc., through Nth resource circuitry 604N, configured to perform other types of aggregation not directly related to the solutions herein, such as, for example, aggregating frequency or performance state votes. Accordingly, in some examples an ARC feature in a SoC may be enhanced in accordance with the solutions described herein by adding an ARC resource configured to operate as described herein. Nevertheless, the above-described low-power mode resource controllers and methods for entering a low-power mode may be provided in any manner.

Implementation examples are described in the following numbered clauses.

1. A method for entering a low-power mode in a system-on-chip (SoC), comprising:

receiving, by a low-power mode resource controller, a power vote from each of a plurality of subsystems in a first power domain when each of the plurality of subsystems is entering the low-power mode;

determining, by the low-power mode resource controller, a winning vote based on power votes received from the plurality of subsystems; and

providing, by the low-power mode resource controller, an indication of entry of the plurality of subsystems into the low-power mode to a second power domain based on the winning vote.

2. The method of clause 1, wherein each power vote is one of an opportunistic entry vote, a commanded entry vote, and a remain active vote.

3. The method of clause 2, wherein:

the opportunistic vote has a first value;

the commanded entry vote has a second value greater than the first value;

the remain active vote has a third value greater than the second value; and

determining the winning vote comprises determining a maximum value among the power votes received from the plurality of subsystems, and providing the indication based on the maximum value.

4. The method of clause 2 or 3, further comprising providing, by a triggering subsystem, a sleep entry command to each of the one or more subsystems, and wherein: each of the plurality of subsystems enters the low-power mode in response to the sleep entry command;

the power vote received from each of the plurality of subsystems is a commanded entry vote; and

providing the indication of entry of the plurality of subsystems into the low-power mode to the second power domain comprises commanding the second power domain to enter the low-power mode.

5. The method of any of clauses 2-4, wherein when the power vote received from each of a plurality of subsystems entering the low-power mode in response to the sleep entry command is an opportunistic entry vote, providing the indication of entry of the plurality of subsystems into the low-power mode to the second power domain comprises notifying the second power domain of an opportunity to enter the low-power mode.

6. The method of any of clauses 1-5, wherein the second power domain is a safety-related power island.

7. The method of any of clauses 1-6, wherein the SoC is included in an automotive computing system.

8. A system for entering a low-power mode in a system-on-chip (SoC), comprising:

aggregated resource control circuitry configured to receive a power vote from each of a plurality of subsystems in a first power domain when each of the plurality of subsystems is entering the low-power mode; and

low-power mode resource circuitry configured to receive power votes from the aggregated resource control circuitry and to determine a winning vote based on the power votes, the low-power mode resource circuitry further configured to provide an indication of entry of the plurality of subsystems into the low-power mode to a second power domain based on the winning vote.

9. The system of clause 8, wherein each power vote is one of an opportunistic entry vote, a commanded entry vote, and a remain active vote.

10. The system of clause 9, wherein:

the opportunistic vote has a first value;

the commanded entry vote has a second value greater than the first value;

the remain active vote has a third value greater than the second value; and

the low-power mode resource circuitry being configured to determine the winning vote comprises being configured to determine a maximum value among the power votes received from the plurality of subsystems and to provide the indication based on the maximum value.

11. The system of clause 9 or 10, further comprising:

a triggering subsystem configured to provide a sleep entry command to each of the one or more subsystems, and wherein:

each of the plurality of subsystems is configured to enter the low-power mode in response to the sleep entry command;

the power vote received from each of the plurality of subsystems is a commanded entry vote; and

the low-power mode resource circuitry being configured to provide the indication of entry of the plurality of subsystems into the low-power mode to the second power domain comprises being configured to command the second power domain to enter the low-power mode.

12. The system of any of clauses 9-11, wherein when the power vote received from each of a plurality of subsystems entering the low-power mode in response to the sleep entry command is an opportunistic entry vote, and the low-power mode resource circuitry being configured to provide the indication of entry of the plurality of subsystems into the low-power mode to the second power domain comprises being configured to notify the second power domain of an opportunity to enter the low-power mode.

13. The system of any of clause 8-12, wherein the second power domain is a safety-related power island.

14. The system of any of clauses 8-13, wherein the SoC is included in an automotive computing system.

15. A system-on-chip (SoC), comprising:

a plurality of subsystems in a first power domain; and

a low-power mode resource controller configured to receive a power vote from each of the plurality of subsystems when each of the plurality of subsystems is entering the low-power mode, the low-power mode resource controller further configured to determine a winning vote based on power votes received from the plurality of subsystems and to provide an indication of entry of the plurality of subsystems into the low-power mode to a second power domain based on the winning vote.

16. The SoC of clause 15, wherein each power vote is one of an opportunistic entry vote, a commanded entry vote, and a remain active vote.

17. The SoC of clause 16, wherein:

the opportunistic vote has a first value;

the commanded entry vote has a second value greater than the first value;

the remain active vote has a third value greater than the second value; and

the low-power mode resource controller being configured to determine the winning vote comprises being configured to determine a maximum value among the power votes received from the plurality of subsystems and to provide the indication based on the maximum value.

18. The SoC of clause 16 or 17, further comprising:

a triggering subsystem configured to provide a sleep entry command to each of the one or more subsystems, and wherein:

each of the plurality of subsystems is configured to enter the low-power mode in response to the sleep entry command;

the power vote received from each of the plurality of subsystems is a commanded entry vote; and

the low-power mode resource controller being configured to provide the indication of entry of the plurality of subsystems into the low-power mode to the second power domain comprises being configured to command the second power domain to enter the low-power mode.

19. The SoC of any of clauses 16-18, wherein when the power vote received from each of a plurality of subsystems entering the low-power mode in response to the sleep entry command is an opportunistic entry vote, and the low-power mode resource controller being configured to provide the indication of entry of the plurality of subsystems into the low-power mode to the second power domain comprises being configured to notify the second power domain of an opportunity to enter the low-power mode.

20. The SoC of any of clauses 15-19, wherein the SoC is included in an automotive computing system.

Alternative embodiments will become apparent to one of ordinary skill in the art to which the invention pertains. Therefore, although selected aspects have been illustrated and described in detail, it will be understood that various substitutions and alterations may be made therein.

What is claimed is:

1. A method for entering a low-power mode in a system-on-chip (SoC), comprising:
receiving, by a low-power mode resource controller, a power vote from each of a plurality of subsystems in a first power domain when each of the plurality of subsystems is entering the low-power mode;
determining, by the low-power mode resource controller, a winning vote based on power votes received from the plurality of subsystems; and
providing, by the low-power mode resource controller, an indication of entry of the plurality of subsystems into the low-power mode to a second power domain based on the winning vote.

2. The method of claim 1, wherein each power vote is one of an opportunistic entry vote, a commanded entry vote, and a remain active vote.

3. The method of claim 2, wherein:
the opportunistic vote has a first value;
the commanded entry vote has a second value greater than the first value;
the remain active vote has a third value greater than the second value; and
determining the winning vote comprises determining a maximum value among the power votes received from the plurality of subsystems, and providing the indication based on the maximum value.

4. The method of claim 2, further comprising providing, by a triggering subsystem, a sleep entry command to each of the one or more subsystems, and wherein:
each of the plurality of subsystems enters the low-power mode in response to the sleep entry command;
the power vote received from each of the plurality of subsystems is a commanded entry vote; and
providing the indication of entry of the plurality of subsystems into the low-power mode to the second power domain comprises commanding the second power domain to enter the low-power mode.

5. The method of claim 2, wherein when the power vote received from each of a plurality of subsystems entering the low-power mode in response to the sleep entry command is an opportunistic entry vote, providing the indication of entry of the plurality of subsystems into the low-power mode to the second power domain comprises notifying the second power domain of an opportunity to enter the low-power mode.

6. The method of claim 1, wherein the second power domain is a safety-related power island.

7. The method of claim 6, wherein the SoC is included in an automotive computing system.

8. A system for entering a low-power mode in a system-on-chip (SoC), comprising:
aggregated resource control circuitry configured to receive a power vote from each of a plurality of subsystems in a first power domain when each of the plurality of subsystems is entering the low-power mode; and
low-power mode resource circuitry configured to receive power votes from the aggregated resource control circuitry and to determine a winning vote based on the power votes, the low-power mode resource circuitry further configured to provide an indication of entry of the plurality of subsystems into the low-power mode to a second power domain based on the winning vote.

9. The system of claim 8, wherein each power vote is one of an opportunistic entry vote, a commanded entry vote, and a remain active vote.

10. The system of claim 9, wherein:
the opportunistic vote has a first value;
the commanded entry vote has a second value greater than the first value;
the remain active vote has a third value greater than the second value; and
the low-power mode resource circuitry being configured to determine the winning vote comprises being configured to determine a maximum value among the power votes received from the plurality of subsystems and to provide the indication based on the maximum value.

11. The system of claim 9, further comprising:
a triggering subsystem configured to provide a sleep entry command to each of the one or more subsystems, and wherein:
each of the plurality of subsystems is configured to enter the low-power mode in response to the sleep entry command;
the power vote received from each of the plurality of subsystems is a commanded entry vote; and
the low-power mode resource circuitry being configured to provide the indication of entry of the plurality of subsystems into the low-power mode to the second power domain comprises being configured to command the second power domain to enter the low-power mode.

12. The system of claim 9, wherein when the power vote received from each of a plurality of subsystems entering the low-power mode in response to the sleep entry command is an opportunistic entry vote, and the low-power mode resource circuitry being configured to provide the indication of entry of the plurality of subsystems into the low-power mode to the second power domain comprises being configured to notify the second power domain of an opportunity to enter the low-power mode.

13. The system of claim 8, wherein the second power domain is a safety-related power island.

14. The system of claim 13, wherein the SoC is included in an automotive computing system.

15. A system-on-chip (SoC), comprising:
a plurality of subsystems in a first power domain; and
a low-power mode resource controller configured to receive a power vote from each of the plurality of subsystems when each of the plurality of subsystems is entering the low-power mode, the low-power mode resource controller further configured to determine a winning vote based on power votes received from the plurality of subsystems and to provide an indication of entry of the plurality of subsystems into the low-power mode to a second power domain based on the winning vote.

16. The SoC of claim 15, wherein each power vote is one of an opportunistic entry vote, a commanded entry vote, and a remain active vote.

17. The SoC of claim 16, wherein:
the opportunistic vote has a first value;
the commanded entry vote has a second value greater than the first value;
the remain active vote has a third value greater than the second value; and
the low-power mode resource controller being configured to determine the winning vote comprises being configured to determine a maximum value among the power votes received from the plurality of subsystems and to provide the indication based on the maximum value.

18. The SoC of claim 16, further comprising:
a triggering subsystem configured to provide a sleep entry command to each of the one or more subsystems, and wherein:
each of the plurality of subsystems is configured to enter the low-power mode in response to the sleep entry command;
the power vote received from each of the plurality of subsystems is a commanded entry vote; and
the low-power mode resource controller being configured to provide the indication of entry of the plurality of subsystems into the low-power mode to the second power domain comprises being configured to command the second power domain to enter the low-power mode.

19. The SoC of claim 16, wherein when the power vote received from each of a plurality of subsystems entering the low-power mode in response to the sleep entry command is an opportunistic entry vote, and the low-power mode resource controller being configured to provide the indication of entry of the plurality of subsystems into the low-power mode to the second power domain comprises being configured to notify the second power domain of an opportunity to enter the low-power mode.

20. The SoC of claim 15, wherein the SoC is included in an automotive computing system.
